(19) United States
(12) Patent Application Publication
(10) Pub. No.: US 2025/0308061 A1
(43) Pub. Date: Oct. 2, 2025

(54) INFORMATION PROCESSING APPARATUS AND REPRESENTATIVE COORDINATE DERIVATION METHOD

(71) Applicant: SONY INTERACTIVE ENTERTAINMENT INC., Tokyo (JP)

(72) Inventors: Takanori MINAMINO, Kanagawa (JP); Kenzo NISHIKAWA, Tokyo (JP)

(21) Appl. No.: 18/725,127

(22) PCT Filed: Dec. 22, 2022
(86) PCT No.: PCT/JP2022/047377

§ 371 Date: Jun. 28, 2024

(30) Foreign Application Priority Data
Feb. 14, 2022 (JP) 2022-020558

(51) Int. Cl. G06T 7/73; G06V 10/147; G06V 10/44

(52) U.S. Cl. CPC G06T 7/73; G06V 10/147; G06V 10/457

(57) ABSTRACT

A photographed image acquisition unit 212 acquires image data vertically inverted and read from an image sensor. A first extraction processing unit 234 extracts connected components of a series of pixels from the image data vertically inverted and read from the image sensor. A representative coordinate derivation unit 238 derives representative coordinates of a marker image on the basis of the pixels of the connected components extracted by the first extraction processing unit 234.

### TECHNICAL FIELD

The present disclosure relates to a technique for detecting a marker image included in a photographed image.

### BACKGROUND ART

An information processing apparatus that specifies representative coordinates of a marker image from an image of a photographed device including a plurality of markers and that uses the representative coordinates of the marker image to derive position information and posture information of the device is disclosed in PTL 1. The information processing apparatus disclosed in PTL 1 specifies a first bounding box surrounding an area of a series of pixels with equal to or greater than a first luminance in the photographed image and specifies a second bounding box surrounding an area of a series of pixels with equal to or greater than a second luminance higher than the first luminance in the first bounding box to thereby derive the representative coordinates of the marker image on the basis of the pixels in the first bounding box or the second bounding box.

An input device including a plurality of light emitting units and a plurality of operation members is disclosed in PTL 2. The light emitting units of the input device are photographed by a camera provided on a head-mounting device, and the position and the posture of the input device are calculated on the basis of the detected positions of the light emitting units.

### CITATION LIST

### Patent Literature

### PTL 1

Japanese Patent Laid-Open No. 2020-181322

### PTL 2

PCT Patent Publication No. WO2021/240930

### SUMMARY

### Technical Problem

In recent years, an information processing technique for tracking the position and the posture of a device and reflecting them on a three-dimensional model of a virtual reality (VR) space is widely used. An information processing apparatus brings the movements of player characters and game objects in a game space into line with changes in the position and the posture of the tracked device to thereby realize the intuitive operation of a user.

A plurality of lighting markers are provided on the device for the purpose of estimating the position and the posture of the device. The information processing apparatus can specify the representative coordinates of a plurality of marker images included in the image of the photographed device and compare the representative coordinates with three-dimensional coordinates of the plurality of markers in the three-dimensional model of the device to thereby estimate the position and the posture of the device in the real space. To estimate the position and the posture of the device at high accuracy, it is necessary to be able to appropriately detect the marker images in the photographed image.

Therefore, an object of the present disclosure is to provide a technique for appropriately detecting marker images in a photographed image. Note that, although the device may be an input device including operation members, the device may be a device that does not include operation members and is merely to be tracked.

### Solution to Problem

To solve the problem described above, an aspect of the present disclosure provides an information processing apparatus including a photographed image acquisition unit that acquires an image of a photographed device including a plurality of markers, and an estimation processing unit that estimates position information and posture information of the device on the basis of a marker image in the photographed image. The estimation processing unit includes a marker image coordinate specifying unit that specifies representative coordinates of the marker image from the photographed image, and a position and posture derivation unit that uses the representative coordinates of the marker image to derive the position information and the posture information of the device. The photographed image acquisition unit acquires image data vertically inverted and read from an image sensor, and the marker image coordinate specifying unit includes an extraction processing unit that extracts connected components of a series of pixels from the image data vertically inverted and read from the image sensor, and a representative coordinate derivation unit that derives the representative coordinates of the marker image on the basis of the pixels of the connected components extracted by the extraction processing unit.

Another aspect of the present disclosure provides a derivation method of representative coordinates including a step of acquiring image data vertically inverted and read from an image sensor that has photographed a device including a plurality of markers, a step of extracting connected components of a series of pixels from the image data, and a step of deriving representative coordinates of a marker image on the basis of the pixels of the extracted connected components.

Note that any combinations of the constituent elements as well as expressions obtained by converting the expressions of the present disclosure among methods, apparatuses, systems, computer programs, recording media in which readable computer programs are recorded, data structures, and the like are also effective as aspects of the present disclosure.

### BRIEF DESCRIPTION OF DRAWINGS

FIG. 1 is a diagram illustrating a configuration example of an information processing system according to an embodiment.

FIG. 2 is a diagram illustrating an example of an external shape of a head-mounted display (HMD).

FIG. 3 is a diagram illustrating functional blocks of the HMD.

FIG. 4 depicts diagrams each illustrating a shape of an input device.

FIG. 5 is a diagram illustrating a shape of the input device.

FIG. 6 is a diagram illustrating an example of part of an image of the photographed input device.

FIG. 7 is a diagram illustrating functional blocks of the input device.

FIG. 8 is a diagram illustrating functional blocks of an information processing apparatus.

FIG. 9 is a flow chart illustrating a position and posture estimation process.

FIG. 10 is a flow chart illustrating a process of extracting connected components of eight neighboring pixels from the photographed image.

FIG. 11 is a diagram illustrating an example of a photographed frame image.

FIG. 12 is a diagram for describing an order of reading line data of the image.

FIG. 13 depicts diagrams for describing connectivity of pixels.

FIG. 14 is a diagram illustrating a plurality of pixels in the photographed image.

FIG. 15 is a diagram illustrating a bounding box surrounding first connected components.

FIG. 16 is a diagram illustrating a bounding box surrounding other first connected components.

FIG. 17 is a diagram illustrating an example of bounding boxes extracted in the photographed image.

FIG. 18 is a diagram illustrating an example in which two marker images are incorrectly extracted as one set of first connected components.

FIG. 19 is a flow chart illustrating a process of extracting a plurality of sets of second connected components from the first connected components.

FIG. 20 is a diagram illustrating an example of a photographed image including an area of the bounding box.

FIG. 21 is a diagram illustrating a target area for extracting the second connected components.

FIG. 22 is a diagram illustrating bounding boxes surrounding the second connected components.

FIG. 23 is a diagram illustrating a flow chart illustrating a derivation process of representative coordinates.

FIG. 24 is a diagram illustrating an example of bounding boxes extracted in a photographed image.

### DESCRIPTION OF EMBODIMENT

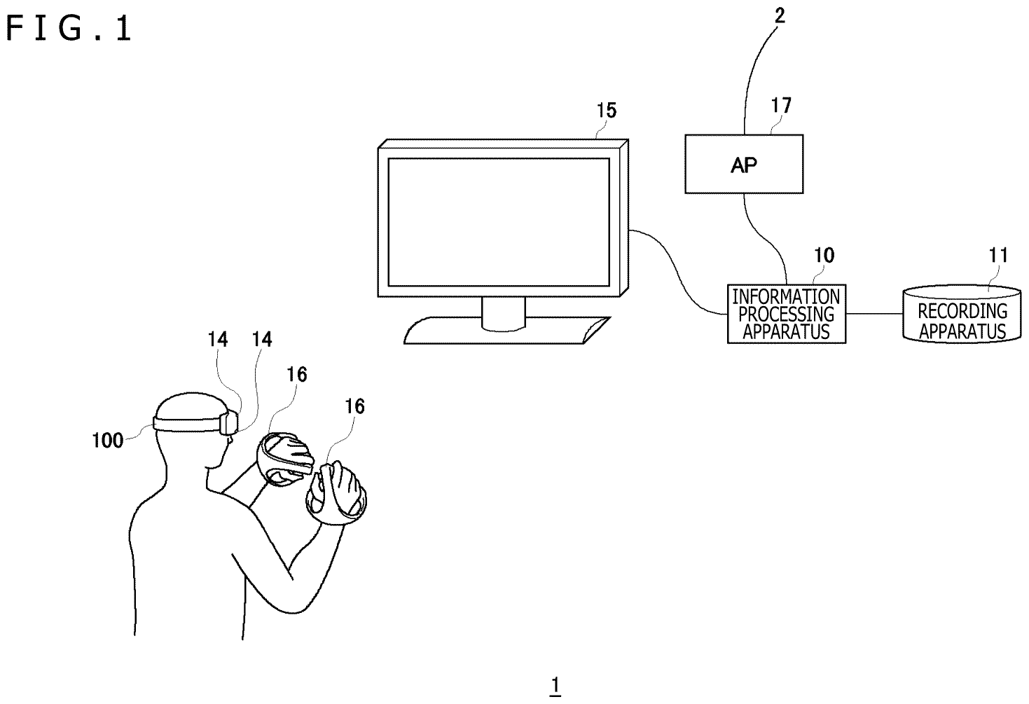

FIG. 1 illustrates a configuration example of an information processing system 1 according to an embodiment. The information processing system 1 includes an information processing apparatus 10, a recording apparatus 11, an HMD 100, input devices 16 operated by a user with fingers, and an output apparatus 15 that outputs images and sounds. The output apparatus 15 may be a television. The information processing apparatus 10 is connected to an external network 2, such as the Internet, through an access point (AP) 17. The AP 17 has a function of a wireless access point and a router. The information processing apparatus 10 may be connected to the AP 17 with a cable or may be connected to the AP 17 by a known wireless communication protocol.

The recording apparatus 11 records applications, such as system software and game software. The information processing apparatus 10 may download the game software from a content server to the recording apparatus 11 through the network 2. The information processing apparatus 10 executes the game software and supplies image data and sound data of the game to the HMD 100. The information processing apparatus 10 and the HMD 100 may be connected to each other by a known wireless communication protocol or may be connected to each other with a cable.

The HMD 100 is a display apparatus that displays images on display panels positioned in front of the eyes of the user when the user wears the HMD 100 on the head. The HMD 100 separately displays a left-eye image on a left-eye display panel and a right-eye image on a right-eye display panel. The images provide parallax images as viewed from left and right points of view, and the images realize a stereoscopic view. The user views the display panels through optical lenses, and therefore, the information processing apparatus 10 supplies the HMD 100 with parallax image data in which the optical distortion caused by the lenses is corrected.

Although the output apparatus 15 is not necessary for the user wearing the HMD 100, the output apparatus 15 can be prepared to allow another user to view the displayed image of the output apparatus 15. Although the information processing apparatus 10 may cause the output apparatus 15 to display the same image as the image viewed by the user wearing the HMD 100, the information processing apparatus 10 may cause the output apparatus 15 to display another image. For example, in a case where the user wearing the HMD and another user play a game together, the output apparatus 15 may display a game image from the point of view of the character of the other user.

The information processing apparatus 10 and the input devices 16 may be connected to each other by a known wireless communication protocol or may be connected to each other with a cable. The input devices 16 include a plurality of operation members, such as operation buttons, and the user uses fingers to operate the operation members while holding the input devices 16. When the information processing apparatus 10 executes the game, the input devices 16 are used as game controllers. The input devices 16 include posture sensors (inertial measurement units (IMUs)) including 3-axis acceleration sensors and 3-axis gyro sensors and transmit sensor data to the information processing apparatus 10 at a predetermined cycle (for example, 800 Hz).

In the game of the embodiment, not only operation information of the operation members of the input devices 16 but also the positions, the postures, the movements, and the like of the input devices 16 are handled as operation information, and the operation information is reflected on the movement of a player character in a virtual three-dimensional space. For example, the operation information of the operation members may be used as information for moving the player character, and the operation information, such as the positions, the postures, and the movements, of the input devices 16 may be used as information for moving the arms of the player character. In a battle scene of the game, the movements of the input devices 16 are reflected on the movements of an armed player character to realize the intuitive operation of the user, and the sense of immersion to the game is increased.

To track the positions and the postures of the input devices 16, a plurality of markers (light emitting units) that can be photographed by imaging devices 14 installed on the HMD 100 are provided on the input devices 16. The information processing apparatus 10 analyzes images of the photographed input devices 16 to estimate position information and posture information of the input devices 16 in the real space, and provides the estimated position information and posture information to the game.

A plurality of imaging devices 14 are installed on the HMD 100. The plurality of imaging devices 14 are attached to the front surface of the HMD 100 at different positions and with different postures, such that the entire imaging range that is the sum of the imaging ranges of the plurality of imaging devices 14 includes all of the field of view of the user. The imaging devices 14 include image sensors that can acquire images of the plurality of markers of the input devices 16. For example, in a case where the markers emit visible light, the imaging devices 14 include visible light sensors, such as charge coupled device (CCD) sensors and complementary metal oxide semiconductor (CMOS) sensors, used in a general digital video camera. In a case where the markers emit invisible light, the imaging devices 14 include invisible light sensors. The plurality of imaging devices 14 photograph the front side of the user at synchronous timing, at a predetermined cycle (for example, 120 frames/second), and transmit image data of the photographed input devices 16 to the information processing apparatus 10.

The information processing apparatus 10 specifies the positions of the plurality of marker images of the input devices 16 included in the photographed images. Note that one input device 16 is photographed by a plurality of imaging devices 14 at the same timing in some cases. However, the attachment positions and the attachment postures of the imaging devices 14 are known, and the information processing apparatus 10 may combine the plurality of photographed images to specify the positions of the marker images.

The three-dimensional shapes of the input devices 16 and the position coordinates of the plurality of markers arranged on the surfaces of the input devices 16 are known, and the information processing apparatus 10 estimates the position coordinates and the postures of the input devices 16 on the basis of the distribution of the marker images in the photographed images. The position coordinates of the input devices 16 may be position coordinates in a three-dimensional space with a reference position as the origin, and the reference position may be position coordinates (latitude, longitude) set before the start of the game.

The information processing apparatus 10 of the embodiment has a function of using the sensor data detected by the posture sensors of the input devices 16, to estimate the position coordinates and the postures of the input devices 16. Therefore, the information processing apparatus 10 of the embodiment may use estimation results based on the images photographed by the imaging devices 14 and estimation results based on the sensor data, to carry out the tracking process of the input devices 16 at high accuracy. In this case, the information processing apparatus 10 may apply a state estimation technique with a Kalman filter to integrate the estimation results based on the photographed images and the estimation results based on the sensor data to thereby specify, at high accuracy, the position coordinates and the postures of the input devices 16 at current time.

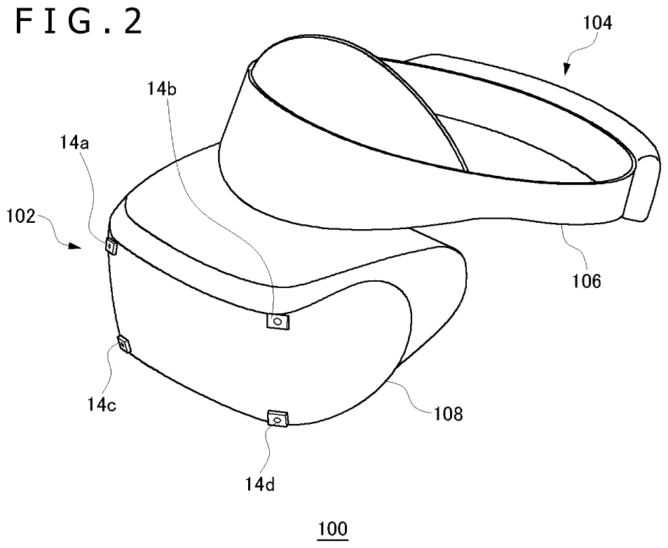

FIG. 2 illustrates an example of an external shape of the HMD 100. The HMD 100 includes an output mechanism unit 102 and an attachment mechanism unit 104. The attachment mechanism unit 104 includes an attachment band 106 worn by the user around the head to fix the HMD 100 to the head. The material and the structure of the attachment band 106 allow the user to adjust the length according to the circumference of the head of the user.

The output mechanism unit 102 includes a housing 108 with a shape covering the left and right eyes when the user wears the HMD 100, and the output mechanism unit 102 internally includes the display panels directly facing the eyes when the user wears the HMD 100. The display panels may be liquid crystal panels, organic electroluminescent (EL) panels, or the like. A pair of left and right optical lenses positioned between the display panels and the eyes of the user and configured to expand the viewing angle of the user are further included inside the housing 108. The HMD 100 may further include speakers or earphones at positions corresponding to the ears of the user, or external headphones may be connected to the HMD 100.

A plurality of imaging devices 14a, 14b, 14c, and 14d are provided on a front side outer surface of the housing 108. With respect to a front face direction of the user, the imaging device 14a is attached to an upper right corner of the front side outer surface such that the camera optical axis points upper right. The imaging device 14b is attached to an upper left corner of the front side outer surface such that the camera optical axis points upper left. The imaging device 14c is attached to a lower right corner of the front side outer surface such that the camera optical axis points lower right. The imaging device 14d is attached to a lower left corner of the front side outer surface such that the camera optical axis points lower left. By installing the plurality of imaging devices 14 in this way, the entire imaging range that is the sum of the imaging ranges of the imaging devices 14 includes all of the field of view of the user. This field of view of the user may be the field of view of the user in a three-dimensional virtual space.

The HMD 100 transmits the sensor data detected by the posture sensors and the image data photographed by the imaging devices 14 to the information processing apparatus 10 and receives game image data and game sound data generated by the information processing apparatus 10.

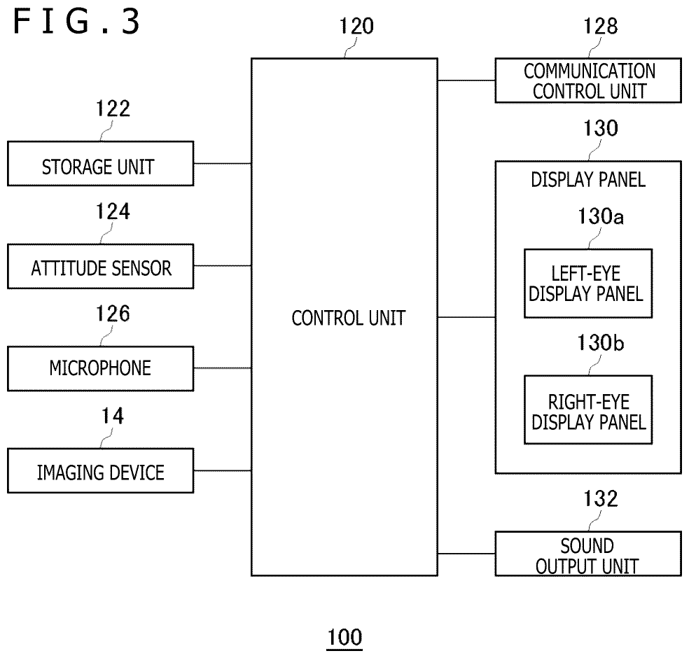

FIG. 3 illustrates functional blocks of the HMD 100. A control unit 120 is a main processor that processes and outputs various types of data, such as image data, sound data, and sensor data, and commands. A storage unit 122 temporarily stores data, commands, and the like processed by the control unit 120. A posture sensor 124 acquires sensor data related to the movement of the HMD 100. The posture sensor 124 includes at least a 3-axis acceleration sensor and a 3-axis gyro sensor. The posture sensor 124 detects a value (sensor data) of each axis component at a predetermined cycle (for example, 800 Hz).

A communication control unit 128 uses a wired or wireless communication to transmit data output from the control unit 120, to the external information processing apparatus 10 through a network adapter or an antenna. The communication control unit 128 also receives data from the information processing apparatus 10 and outputs the data to the control unit 120.

When the control unit 120 receives the game image data and the game sound data from the information processing apparatus 10, the control unit 120 supplies the data to a display panel 130 to cause the display panel 130 to display the data and supplies the data to a sound output unit 132 to cause the sound output unit 132 to output the sound. The display panel 130 includes a left-eye display panel 130a and a right-eye display panel 130b, and a pair of parallax images are displayed on the display panels. The control unit 120 also causes the communication control unit 128 to transmit, to the information processing apparatus 10, the sensor data received from the posture sensor 124, sound data received from a microphone 126, and the photographed image data received from the imaging devices 14.

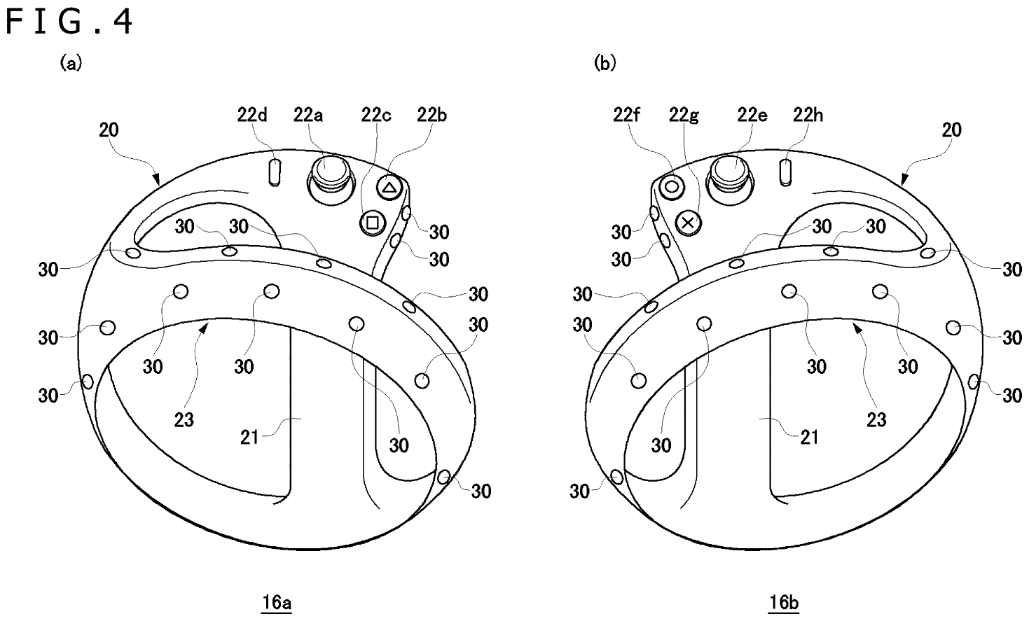

FIG. 4 (a) illustrates a shape of a left-hand input device 16a. The left-hand input device 16a includes a case body 20, a plurality of operation members 22a, 22b, 22c, and 22d operated by the user (hereinafter, referred to as “operation members 22” in a case where they are not particularly distinguished from one another), and a plurality of markers 30 that emit light to the outside of the case body 20. The markers 30 may include emission surfaces with circular cross sections. The operation members 22 may include an analog stick that is tilted and operated, a push button, and the like. The case body 20 includes a holding unit 21 and a curved unit 23 that connects a case body head portion and a case body bottom portion. The user puts the left hand into the curved unit 23 and holds the holding unit 21. While the user is holding the holding unit 21, the user uses the thumb of the left hand to operate the operation members 22a, 22b, 22c, and 22d.

FIG. 4 (b) illustrates a shape of a right-hand input device 16b. The right-hand input device 16b includes a case body 20, a plurality of operation members 22e, 22f, 22g, and 22h operated by the user (hereinafter, referred to as “operation members 22” in a case where they are not particularly distinguished from one another), and a plurality of markers 30 that emit light to the outside of the case body 20. The operation members 22 may include an analog stick that is tilted and operated, a push button, and the like. The case body 20 includes a holding unit 21 and a curved unit 23 that connects a case body head portion and a case body bottom portion to each other. The user puts the right hand into the curved unit 23 and holds the holding unit 21. While the user is holding the holding unit 21, the user uses the thumb of the right hand to operate the operation members 22e, 22f, 22g, and 22h.

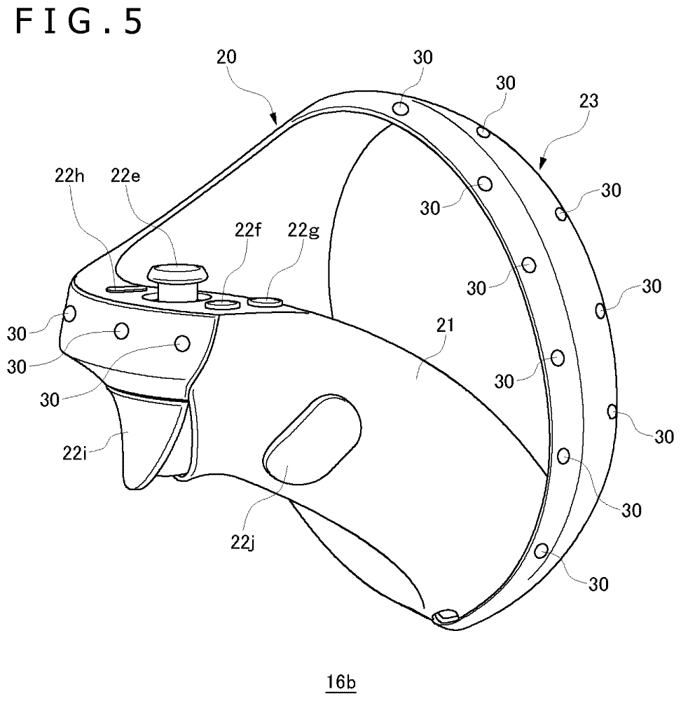

FIG. 5 illustrates a shape of the right-hand input device 16b. The input device 16b includes operation members 22i and 22j in addition to the operation members 22e, 22f, 22g, and 22h illustrated in FIG. 4 (b). While the user is holding the holding unit 21, the user uses the index finger of the right hand to operate the operation member 22i and uses the middle finger to operate the operation member 22j. Hereinafter, the input device 16a and the input device 16b will be referred to as “input devices 16” in a case where they are not particularly distinguished to each other.

The operation members 22 provided on the input devices 16 have a touch sense function of recognizing fingers just by the user touching the operation members 22 without pressing the operation members 22. In relation to the right-hand input device 16b, the operation members 22f, 22g, and 22j may include electrostatic-capacitance touch sensors. Note that, although the touch sensors may be installed on other operation members 22, it is preferable that the touch sensors be installed on operation members not coming into contact with the placement surface when the input devices 16 are placed on a table or the like.

The markers 30 are light emitting units that emit light to the outside of the case bodies 20, and the markers 30 include resin units that diffuse and emit light from light sources, such as a light emitting diode (LED) elements, to the outside on the surfaces of the case bodies 20. The markers 30 are photographed by the imaging devices 14 and used for the estimation process of the positions and the postures of the input devices 16. The imaging devices 14 photograph the space at a predetermined cycle (for example, 120 frames/second). Therefore, it is preferable that the markers 30 emit the light in synchronization with the cyclical photographed timing of the imaging devices 14 and be turned off in a non-exposure period of the imaging devices 14 to suppress unnecessary power consumption.

In the embodiment, the images photographed by the imaging devices 14 are used for the tracking process of the input devices 16 and the tracking process (simultaneous localization and mapping (SLAM)) of the HMD 100. Therefore, images photographed at 60 frames/second may be used for the tracking process of the input devices 16, and other images photographed at 60 frames/second may be used for a process of estimating the self-position of the HMD 100 and creating an environmental map at the same time.

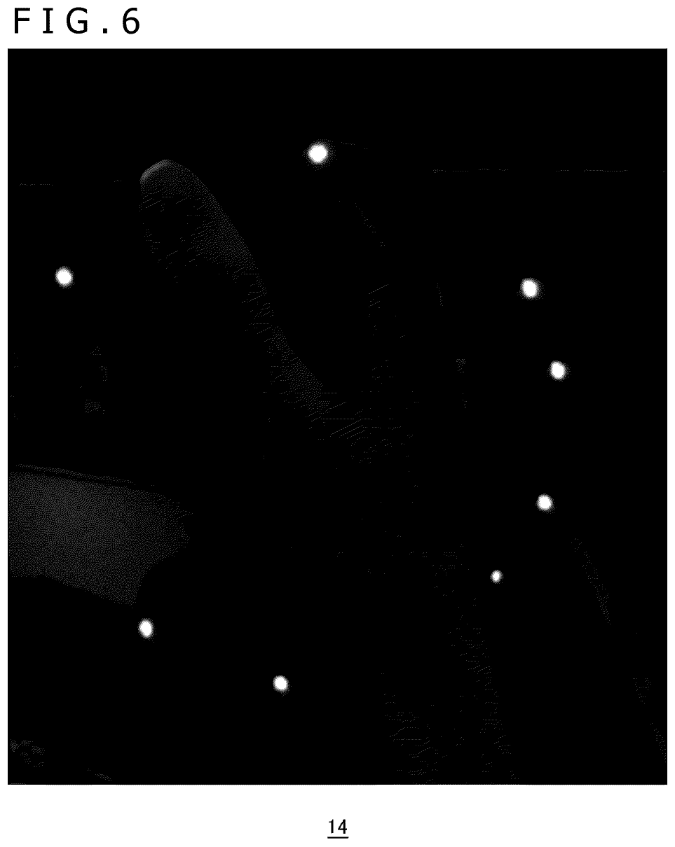

FIG. 6 illustrates an example of part of the image of the photographed input device 16. This image is a photographed image of the input device 16b held by the right hand, and includes an image of the plurality of markers 30 that emit light. In the HMD 100, the communication control unit 128 transmits the image data photographed by the imaging device 14 to the information processing apparatus 10 at a predetermined cycle.

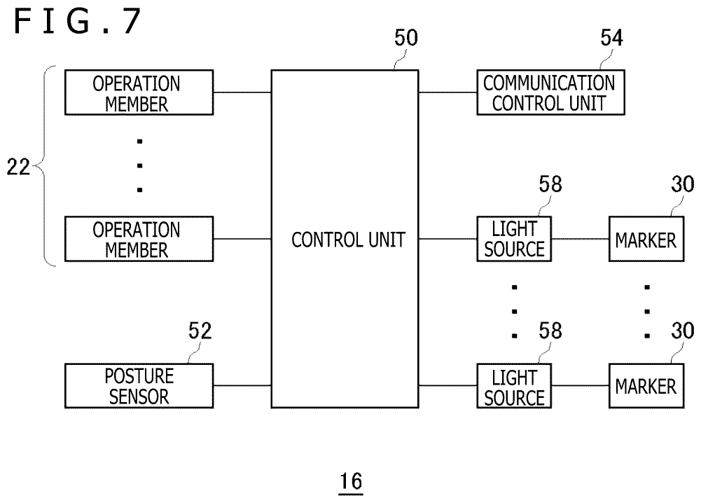

FIG. 7 illustrates functional blocks of the input device 16. A control unit 50 receives operation information input to the operation members 22 and also receives sensor data acquired by a posture sensor 52. The posture sensor 52 acquires sensor data related to the movement of the input device 16 and includes at least a 3-axis acceleration sensor and a 3-axis gyro sensor. The posture sensor 52 detects a value (sensor data) of each axis component at a predetermined cycle (for example, 800 Hz). The control unit 50 supplies the received operation information and sensor data to a communication control unit 54. The communication control unit 54 uses wired or wireless communication to transmit the operation information and the sensor data output from the control unit 50, to the information processing apparatus 10 through a network adaptor or an antenna. The communication control unit 54 also acquires a light emitting instruction from the information processing apparatus 10.

The input device 16 includes a plurality of light sources 58 for turning on the plurality of markers 30. The light sources 58 may be LED elements that emit light in a predetermined color. The control unit 50 causes the light sources 58 to emit light to turn on the markers 30, on the basis of the light emitting instruction acquired from the information processing apparatus 10. Note that, although one light source 58 is provided for one marker 30 in the example illustrated in FIG. 7, one light source 58 may turn on a plurality of markers 30.

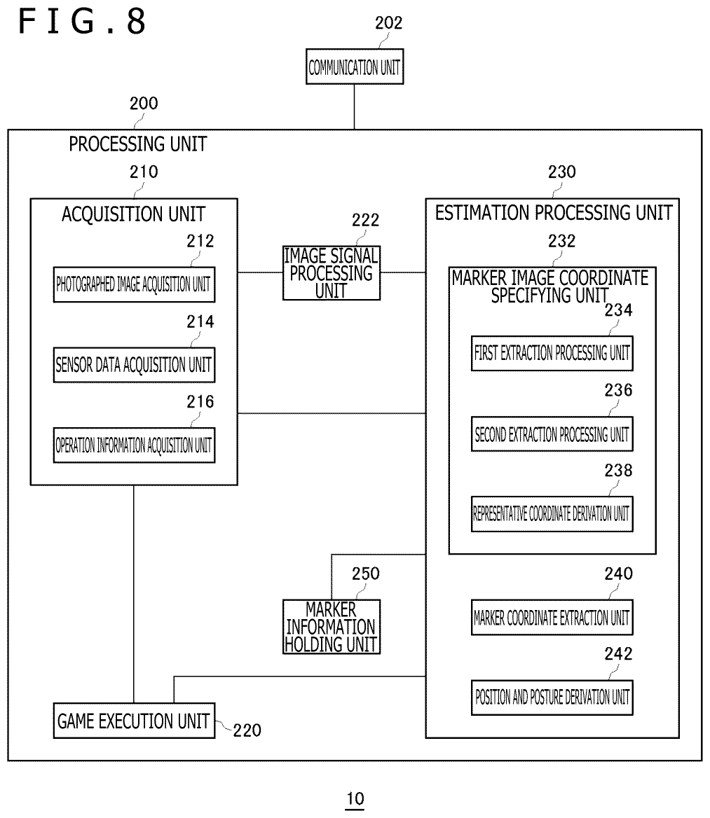

FIG. 8 illustrates functional blocks of the information processing apparatus 10. The information processing apparatus 10 includes a processing unit 200 and a communication unit 202, and the processing unit 200 includes an acquisition unit 210, a game execution unit 220, an image signal processing unit 222, an estimation processing unit 230, and a marker information holding unit 250. The communication unit 202 receives the operation information and the sensor data of the operation members 22 transmitted from the input devices 16 and supplies the operation information and the sensor data to the acquisition unit 210. The communication unit 202 also receives the photographed image data and the sensor data transmitted from the HMD 100 and supplies the photographed image data and the sensor data to the acquisition unit 210.

The acquisition unit 210 includes a photographed image acquisition unit 212, a sensor data acquisition unit 214, and an operation information acquisition unit 216. The estimation processing unit 230 includes a marker image coordinate specifying unit 232, a marker image coordinate extraction unit 240, and a position and posture derivation unit 242, and the marker image coordinate specifying unit 232 includes a first extraction processing unit 234, a second extraction processing unit 236, and a representative coordinate derivation unit 238. The estimation processing unit 230 estimates the position information and the posture information of the input devices 16 on the basis of the marker images included in the photographed images. Note that, although not described in the embodiment, the estimation processing unit 230 may input, to a Kalman filter, the position information and the posture information of the input devices 16 estimated from the marker images included in the photographed images and the position information and the posture information of the input devices 16 estimated from the sensor data detected by the input devices 16, to thereby estimate the position information and the posture information of the input devices 16 at high accuracy. The estimation processing unit 230 supplies the estimated position information and posture information of the input devices 16 to the game execution unit 220.

The information processing apparatus 10 includes a computer, and the computer executes programs to realize various functions illustrated in FIG. 8. The computer includes, as hardware, a memory loaded with programs, one or more processors that execute the loaded programs, an auxiliary storage apparatus, and other large-scale integration (LSI) circuits. The processor includes a plurality of electronic circuits including semiconductor integrated circuits and LSI circuits. The plurality of electronic circuits may be installed on one chip or may be installed on a plurality of chips. The functional blocks illustrated in FIG. 8 are realized by cooperation between hardware and software. Therefore, those skilled in the art will understand that the functional blocks can be realized in various forms by only hardware, only software, or combinations of hardware and software.

The photographed image acquisition unit 212 acquires the image data of the photographed input devices 16 including the plurality of markers 30 and supplies the image data to the image signal processing unit 222. The image signal processing unit 222 applies image signal processing such as noise reduction and optical correction (shading correction) to the image data and supplies the photographed image data with improved image quality to the estimation processing unit 230.

The photographed image acquisition unit 212 supplies line data in the horizontal direction of the image to the image signal processing unit 222 one line at a time. The image signal processing unit 222 of the embodiment includes hardware. The image signal processing unit 222 stores the image data of several lines in a line buffer, applies an image quality improvement process to the image data of several lines stored in the line buffer, and supplies the line data with improved image quality to the estimation processing unit 230.

The sensor data acquisition unit 214 acquires the sensor data transmitted from the input devices 16 and the HMD 100 and supplies the sensor data to the estimation processing unit 230. The operation information acquisition unit 216 acquires the operation information transmitted from the input devices 16 and supplies the operation information to the game execution unit 220. The game execution unit 220 advances the game on the basis of the operation information and the position and posture information of the input devices 16.

The marker image coordinate specifying unit 232 specifies two-dimensional coordinates (hereinafter, also referred to as “marker image coordinates”) representing the images of the markers 30 included in the photographed images. The marker image coordinate specifying unit 232 may specify an area of a series of pixels with luminance values equal to or greater than a predetermined value, calculate barycentric coordinates of the pixel area, and set the barycentric coordinates as the representative coordinates of the marker image. The method of deriving the representative coordinates by the marker image coordinate specifying unit 232 will be described later.

A method of solving a perspective n-point (PNP) problem is known as a method of estimating, from a photographed image of an object with known three-dimensional shape and size, the position and the posture of an imaging device that has photographed the object. In the embodiment, the marker image coordinate extraction unit 240 extracts N (N is an integer equal to or greater than three) two-dimensional marker image coordinates in the photographed image, and the position and posture derivation unit 242 derives the position information and the posture information of the input device 16 from the N marker image coordinates extracted by the marker image coordinate extraction unit 240 and from three-dimensional coordinates of N markers in the three-dimensional model of the input device 16. The position and posture derivation unit 242 uses the following (Equation 1) to estimate the position and the posture of the imaging device 14 and derives the position information and the posture information of the input device 16 in the three-dimensional space on the basis of the estimation result.

$$\begin{matrix}[ Math . 1 ] & \\ s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] & ( Equation 1 )\end{matrix}$$

Here, (u, v) represents the marker image coordinates in the photographed image, and (X, Y, Z) represents the position coordinates of the marker 30 in the three-dimensional space when the three-dimensional model of the input device 16 is at the reference position and with the reference posture. Note that the three-dimensional model is a model which has completely the same shape and size as those of the input device 16 and in which the markers are arranged at the same positions. The marker information holding unit 250 holds three-dimensional coordinates of each marker in the three-dimensional model which is at the reference position and with the reference posture. The position and posture derivation unit 242 reads the three-dimensional coordinates of each marker from the marker information holding unit 250 to acquire (X, Y, Z).

In the equation, (fₓ, f_{y}) represents the focal length of the imaging device 14, and (cₓ, c_{y}) represents the image principal point. They are both internal parameters of the imaging device 14. The matrix with elements r₁₁ to r₃₃ and t₁ to t₃ is a rotation/translation matrix. In (Equation 1), (u, v), (fₓ, f_{y}), (cₓ, c_{y}), and (X, Y, Z) are known, and the position and posture derivation unit 242 solves the equations for N markers 30 to obtain the rotation/translation matrix common to them. The position and posture derivation unit 242 derives the position information and the posture information of the input device 16 on the basis of the angle and the amount of translation indicated by this matrix. In the embodiment, the process of estimating the position and the posture of the input device 16 is carried out by solving the P3P problem, and therefore, the position and posture derivation unit 242 uses three marker image coordinates and three three-dimensional marker coordinates in the three-dimensional model of the input device 16 to derive the position and the posture of the input device 16. The information processing apparatus 10 uses the SLAM technique to generate world coordinates of the three-dimensional real space, and therefore, the position and posture derivation unit 242 derives the position and the posture of the input device 16 in the world coordinate system.

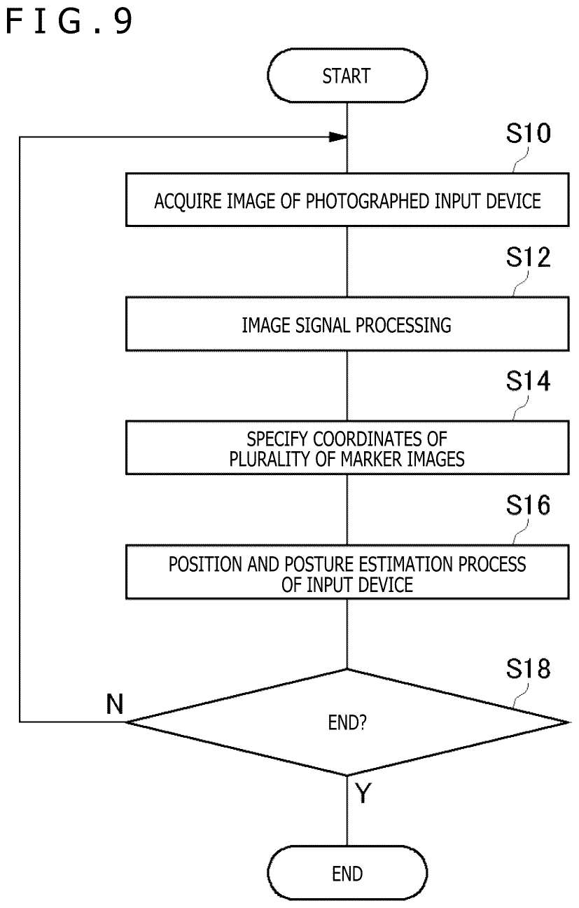

FIG. 9 is a flow chart illustrating a position and posture estimation process executed by the estimation processing unit 230. The photographed image acquisition unit 212 sequentially acquires the line data of the image of the photographed input device 16 (S10) and supplies the line data to the image signal processing unit 222. Note that, to reduce the calculation load of the position and posture estimation process, the photographed image acquisition unit 212 may execute a binning process of two pieces of acquired line data (process of grouping four pixels into one pixel) and supply the data to the image signal processing unit 222. The image signal processing unit 222 stores the line data of several lines in the line buffer and executes the image signal processing such as noise reduction and optical correction (S12). The image signal processing unit 222 supplies the line data obtained after the image signal processing to the marker image coordinate specifying unit 232, and the marker image coordinate specifying unit 232 specifies the representative coordinates of a plurality of marker images included in the photographed image (S14). The line data obtained after the image signal processing and the specified representative coordinates of the marker images are temporarily stored in the memory (not illustrated).

The marker image coordinate extraction unit 240 extracts three freely-selected marker image coordinates from the plurality of marker image coordinates specified by the marker image coordinate specifying unit 232. The marker information holding unit 250 holds the three-dimensional coordinates of each marker in the three-dimensional model of the input device 16 which is at the reference position and with the reference posture. The position and posture derivation unit 242 reads the three-dimensional coordinates of the markers in the three-dimensional model from the marker information holding unit 250 and uses (Equation 1) to solve the P3P problem. When the position and posture derivation unit 242 specifies the rotation/translation matrix common to the three extracted marker image coordinates, the position and posture derivation unit 242 uses the marker image coordinates of the input device 16 other than the three extracted marker image coordinates to calculate reprojection errors.

The marker image coordinate extraction unit 240 extracts a predetermined number of combinations of three marker image coordinates. The position and posture derivation unit 242 specifies the rotation/translation matrix for each extracted combination of three marker image coordinates and calculates reprojection errors of them. The position and posture derivation unit 242 then specifies the rotation/translation matrix with the minimum reprojection errors from a predetermined number of reprojection errors and derives the position information and the posture information of the input device 16 (S16). The position and posture derivation unit 242 supplies the derived position information and posture information of the input device 16 to the game execution unit 220.

The position and posture estimation process is carried out at an imaging cycle (60 frames/second) of the tracking image of the input device 16 (N in S18). When the game execution unit 220 ends the game, the position and posture estimation process by the estimation processing unit 230 ends (Y in S18).

Hereinafter, the method of deriving the representative coordinates of the marker images by the marker image coordinate specifying unit 232 will be described with reference to a plurality of flow charts. The photographed image of the embodiment is a grayscale image. The luminance of each pixel is expressed in eight bits, and the luminance value is from zero to 255. In the photographed image, the marker images are photographed as images with high luminance as illustrated in FIG. 6.

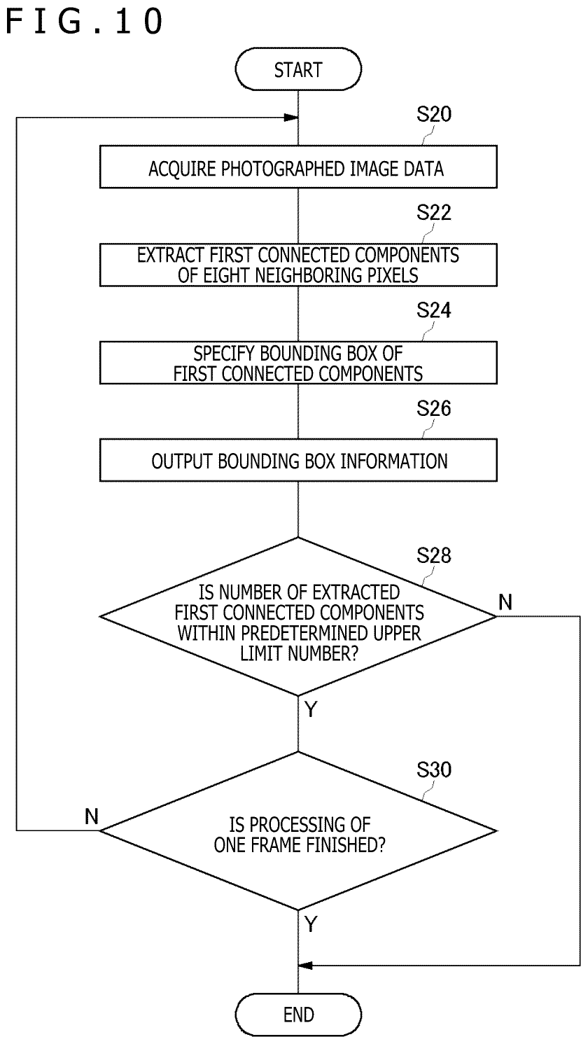

FIG. 10 is a flow chart illustrating a process of extracting connected components of eight neighboring pixels from the photographed image executed by the first extraction processing unit 234. The first extraction processing unit 234 acquires the line data obtained after the image signal processing, from the image signal processing unit 222 (S20). The first extraction processing unit 234 carries out a process of extracting connected components of eight neighboring pixels from the photographed image (S22).

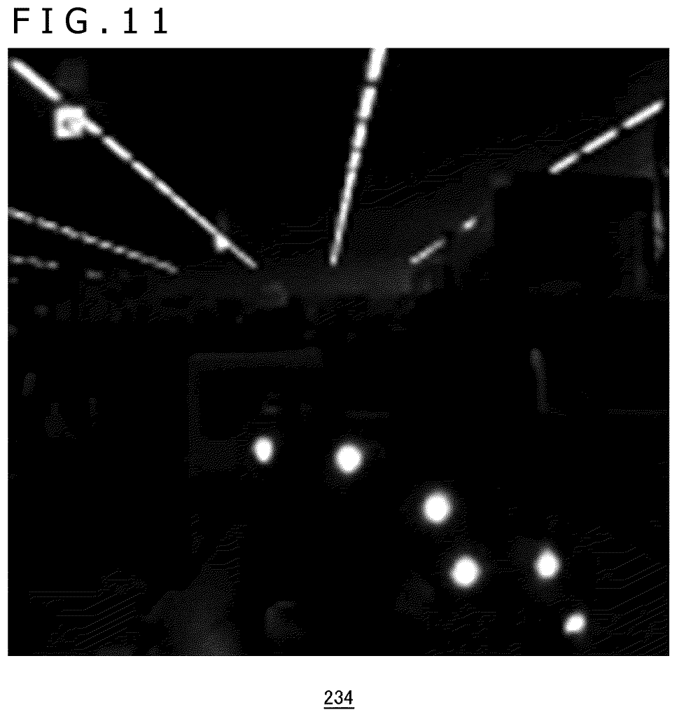

FIG. 11 illustrates an example of a photographed frame image. Objects with high luminance included in the lower part of the image are the markers 30 emitting light. The image signal processing unit 222 sequentially supplies the line data in the horizontal direction of the frame image to the first extraction processing unit 234 from the top in the vertical direction. The line data supplied from the image signal processing unit 222 may be sequentially stored in the memory (not illustrated).

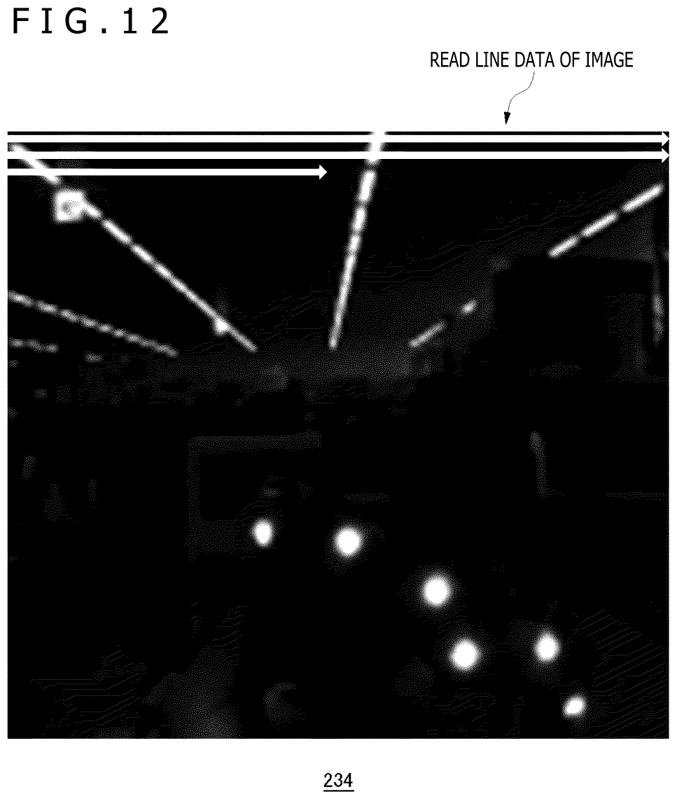

FIG. 12 is a diagram for describing the order of reading the line data of the image. The first extraction processing unit 234 carries out a process of sequentially receiving the line data in the horizontal direction of the frame image from the top and extracting the connected components of eight neighboring pixels.

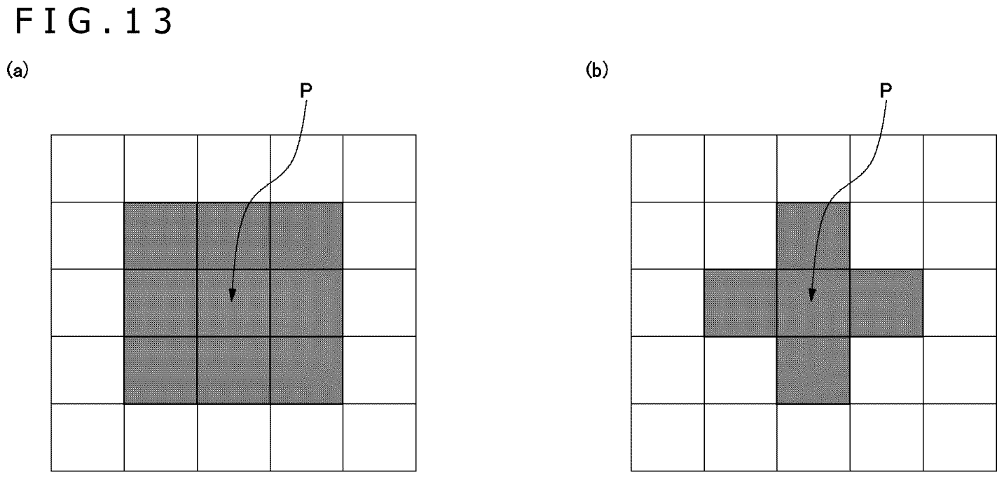

FIG. 13 (a) is a diagram for describing the eight neighboring pixels. In a connected-component labeling (CCL) algorithm, pixels around one pixel P (up, down, left, and right directions and four diagonal directions) are called “eight neighboring pixels.” When two pixels with the same value are in eight neighborhoods in a binary image, the two pixels are called “eight adjacencies,” and a set of a plurality of pixels connected to one another in eight adjacencies will be referred to as “first connected components” in the present embodiment. The first extraction processing unit 234 includes hardware. When two or three pieces of line data are input from the image signal processing unit 222, the first extraction processing unit 234 carries out a process of extracting the connected components of eight neighboring pixels.

Meanwhile, as described later, the second extraction processing unit 236 of the embodiment uses software calculation to carry out a process of extracting connected components of four neighboring pixels. FIG. 13 (b) is a diagram for describing the four neighboring pixels. Pixels in the up, down, left, and right directions around one pixel P are called “four neighboring pixels.” The four neighboring pixels do not include pixels in the diagonal directions. When two pixels with the same value are in four neighborhoods in a binary image, the two pixels are called “4 adjacencies,” and a set of a plurality of pixels connected in 4 adjacencies will be referred to as “second connected components” in the present embodiment. The processing function of the second extraction processing unit 236 is realized by software calculation based on digital signal processor (DSP), and the second extraction processing unit 236 in the embodiment applies a process of extracting the connected components of four neighboring pixels to the connected components extracted by the first extraction processing unit 234.

In a case where the connected components of eight neighboring pixels and the connected components of four neighboring pixels are independently and separately extracted from one same frame image, the connected components of eight neighborhoods also include pixels connected in the diagonal directions. Therefore, the size of the connected components of eight neighborhoods is equal to or greater than the size of the connected components of four neighborhoods, and the number of extracted connected components of eight neighborhoods is equal to or smaller than the number of extracted connected components of four neighborhoods.

The extraction process (S22) of the first connected components of eight neighboring pixels executed by the first extraction processing unit 234 will be described with reference again to FIG. 10. The first extraction processing unit 234 searches for an area in which pixels with equal to or greater than a first luminance are connected to one another in eight neighborhoods in the photographed image. For example, the first luminance may be a luminance value of 128. The first extraction processing unit 234 extracts the connected components of eight neighboring pixels. Therefore, compared to the case of extracting the connected components of four neighboring pixels, the number of extracted connected components can be smaller, and the load on a derivation process of marker image representative coordinates in a later stage can be reduced.

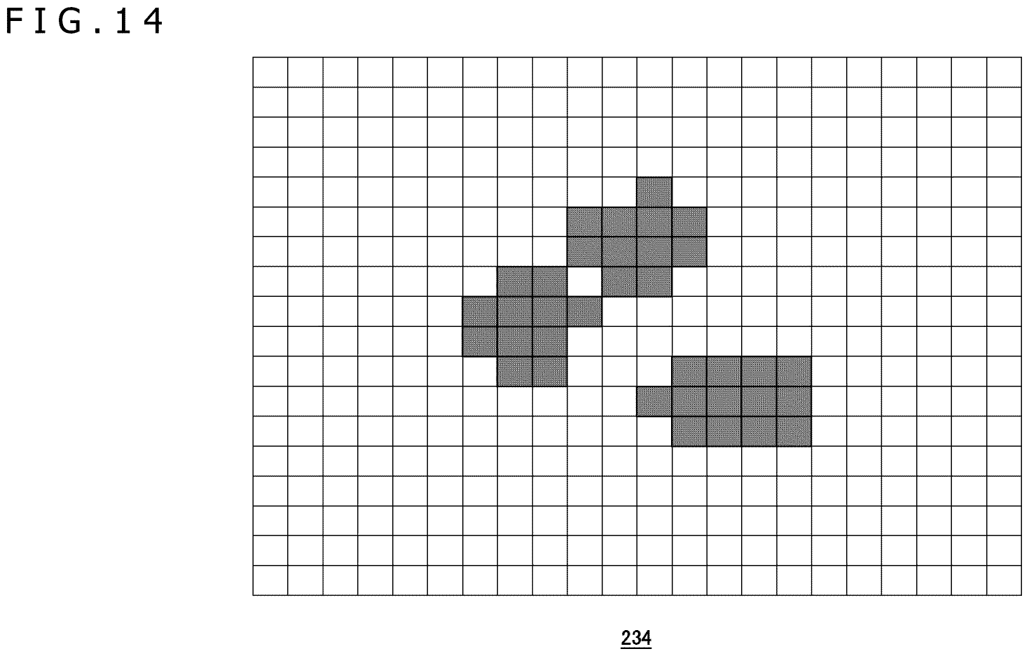

FIG. 14 illustrates an example of a plurality of pixels in the photographed image. In the grayscale image actually photographed, the pixel with the highest luminance value of 255 is expressed in white, and the pixel with the lowest luminance value of zero is expressed in black. However, in the following FIGS. 14 to 16 and FIGS. 20 to 22, the visibility is prioritized, and the luminance expression of each pixel is inverted (white and black are inverted). Therefore, in FIGS. 14 to 16 and FIGS. 20 to 22, black expresses the luminance value of 255 (highest luminance value), and white expresses the luminance value of zero (lowest luminance value). When the first extraction processing unit 234 finds the area in which the pixels with equal to or greater than the first luminance are connected in eight neighborhoods, the first extraction processing unit 234 extracts this area as first connected components of eight neighboring pixels (S22) and specifies a bounding box surrounding the first connected components (S24).

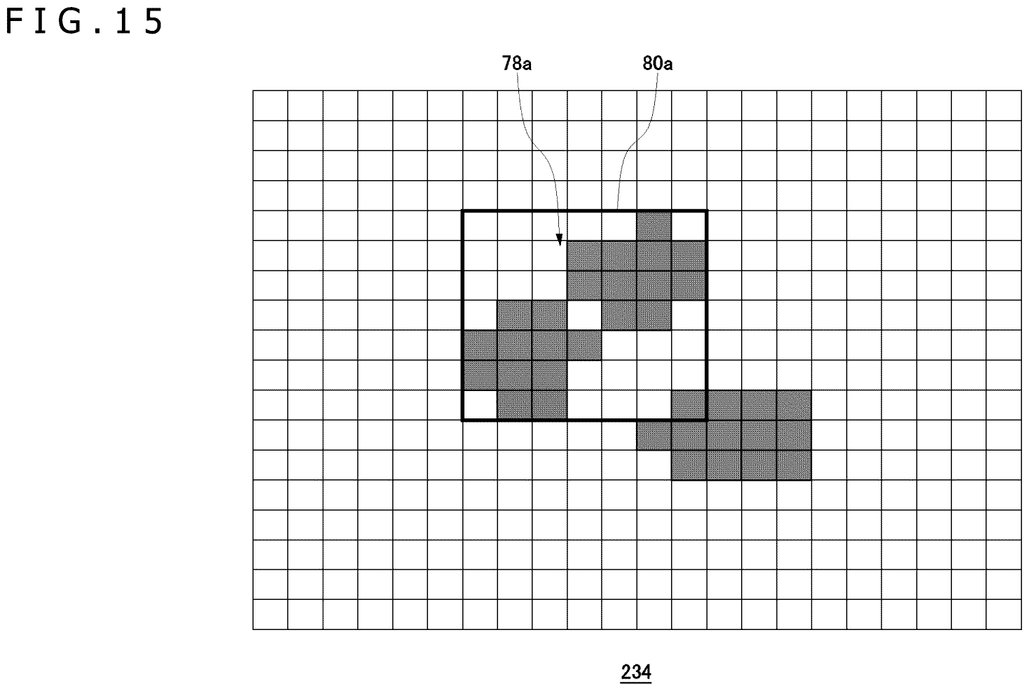

FIG. 15 illustrates a bounding box 80a surrounding extracted first connected components 78a of eight neighboring pixels. The bounding box 80a is specified as a minimum rectangle surrounding the first connected components 78a of eight neighboring pixels. Note that the first extraction processing unit 234 carries out the extraction process of the first connected components for each piece of line data of the image, and the first extraction processing unit 234 does not recognize the presence of other first connected components illustrated below, when the first extraction processing unit 234 extracts the first connected components 78a. When the first extraction processing unit 234 specifies the bounding box 80a, the first extraction processing unit 234 outputs and stores coordinate information (bounding box information) of the bounding box 80a in the memory (not illustrated) (S26).

Here, the first extraction processing unit 234 determines whether the number of extracted first connected components is within a predetermined upper limit number (S28). For example, the upper limit number may be set to 256. In the embodiment, the position and posture estimation process is carried out at the imaging cycle (60 frames/second) of the tracking image of the input device 16. Therefore, it is difficult to complete the position and posture estimation process within the imaging cycle when the number of extracted first connected components is enormous. Thus, the upper limit number is set for the number of first connected components extracted by the first extraction processing unit 234. If the number of extracted first connected components exceeds the upper limit number (N in S28), the first extraction processing unit 234 forcibly ends the extraction process of the first connected components.

In a case where the number of extracted first connected components is within the predetermined upper limit number (Y in S28), steps S20 to S26 are repeatedly carried out until the process for one frame of the photographed image is finished (N in S30).

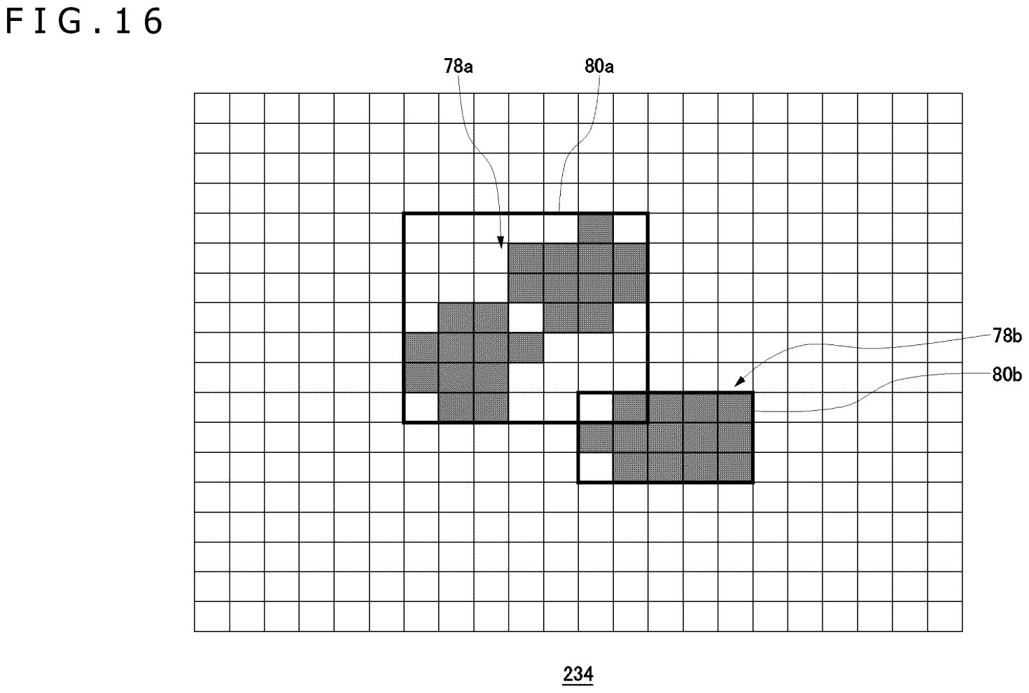

FIG. 16 illustrates a bounding box 80b surrounding other first connected components 78b extracted in S22. The bounding box 80b is specified as a minimum rectangle surrounding the first connected components 78b of eight neighboring pixels. The first extraction processing unit 234 outputs coordinate information of the bounding box 80b to the memory. When the process for one frame of the photographed image is finished (Y in S30), the first extraction processing unit 234 starts the process for the next frame image.

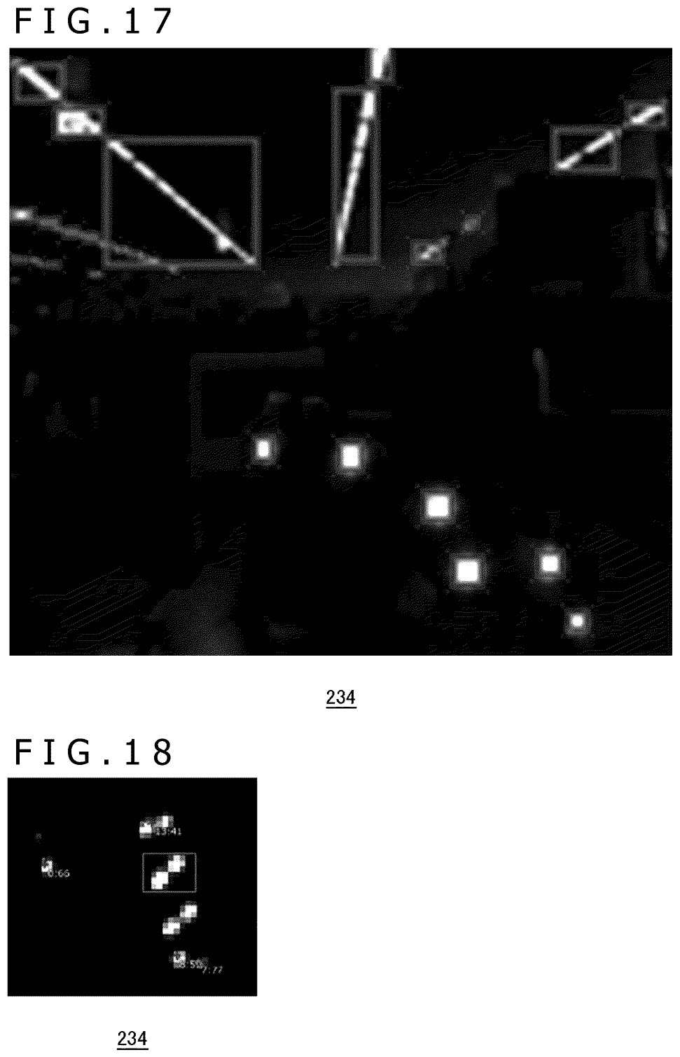

FIG. 17 illustrates an example of bounding boxes extracted in the photographed image. The first extraction processing unit 234 extracts a plurality of sets of first connected components of eight neighboring pixels from the photographed image, and outputs and stores, in the memory, information regarding the bounding boxes surrounding the plurality of sets of first connected components. In the example illustrated in FIG. 17, bounding boxes of marker images are specified on the lower side of the photographed image, and bounding boxes of light source images of illumination light or the like are specified on the upper side of the photographed image.

In the example illustrated in FIG. 17, the user operates the input devices 16 at positions close to the HMD 100, and bounding boxes surrounding large marker images are specified on the lower side of the photographed image. However, if, for example, the user fully stretches the hands forward and operates the input devices 16 at that position, the distance between the input devices 16 and the imaging devices 14 becomes far, and the photographed marker images become small. In a case where a plurality of marker images are close to each other, the first extraction processing unit 234 incorrectly extracts the plurality of marker images as one set of first connected components in some cases.

FIG. 18 illustrates an example in which two marker images are incorrectly extracted as one set of first connected components. In the example illustrated in FIG. 18, two small marker images are connected to each other in eight neighborhoods. As a result, the first extraction processing unit 234 extracts two marker images as one set of first connected components and specifies a bounding box surrounding two marker images. Therefore, the second extraction processing unit 236 of the embodiment has a function of applying a separation process to a plurality of marker images included in the bounding box specified by the first extraction processing unit 234.

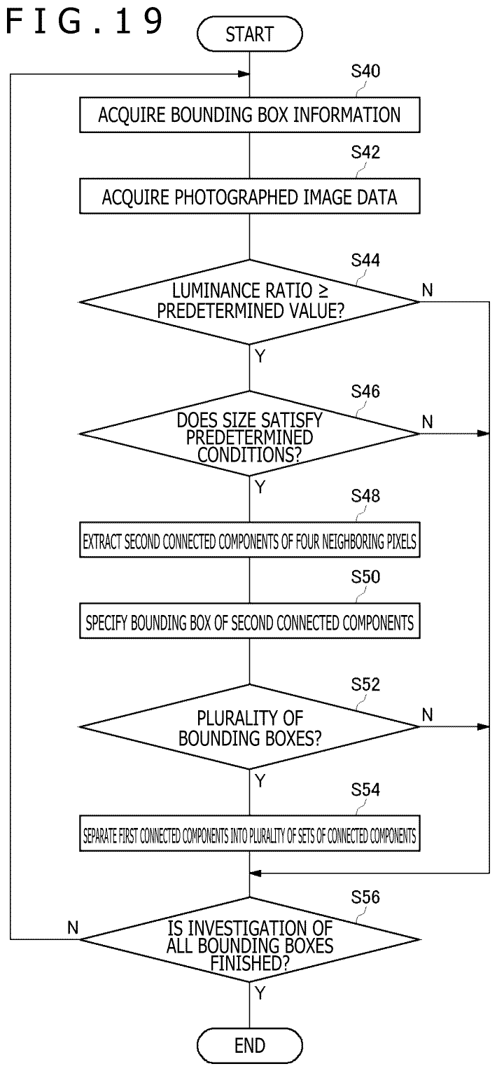

FIG. 19 is a flow chart illustrating a process of extracting, by the second extraction processing unit 236, a plurality of sets of second connected components of four neighboring pixels from the first connected components included in the bounding box. The second extraction processing unit 236 investigates whether the first connected components extracted by the first extraction processing unit 234 can be separated into a plurality of sets of second connected components of four neighboring pixels. In a case where the first connected components can be separated, the second extraction processing unit 236 discards the original first connected components and replaces the original first connected components with a plurality of sets of second connected components obtained after the separation. In a case where the first connected components cannot be separated, the second extraction processing unit 236 maintains the original first connected components.

The second extraction processing unit 236 acquires the bounding box information (coordinate information) specified by the first extraction processing unit 234, from the memory (S40). At this point, the second extraction processing unit 236 also acquires the photographed image data including the bounding box and the surroundings of the bounding box from the memory storing the photographed image data (S42).

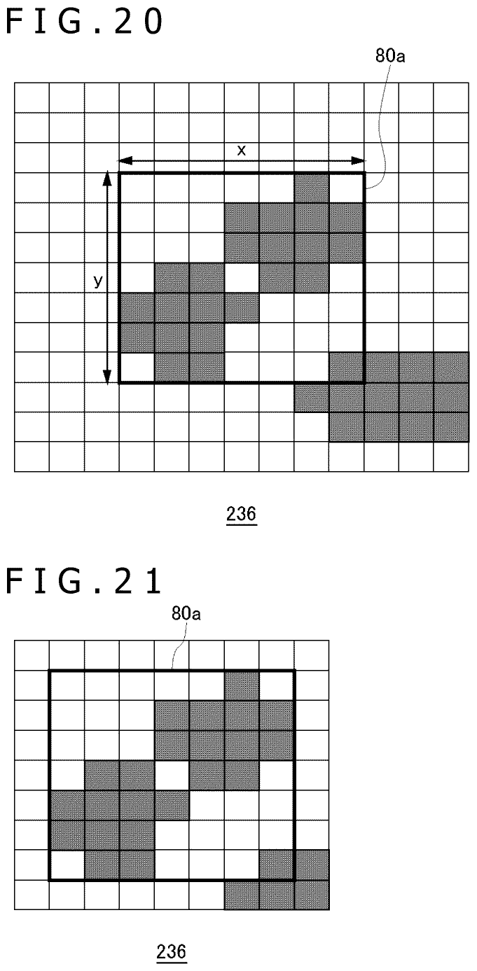

FIG. 20 illustrates an example of the photographed image including the area of the bounding box 80a. The horizontal length and the vertical length of the acquired photographed image area are substantially twice the horizontal length and the vertical length of the bounding box 80a, and the center position of the image area is set to substantially coincide with the center position of the bounding box 80a. The second extraction processing unit 236 checks the contrast between the bounding box 80a specified by the first extraction processing unit 234 and the surroundings of the bounding box 80a (S44). If the bounding box 80a includes a marker image, the average luminance in the bounding box 80a is high. On the other hand, the average luminance outside the bounding box 80a is relatively low. Therefore, the second extraction processing unit 236 calculates the average luminance in the bounding box 80a and the average luminance in the area outside the bounding box 80a in the acquired image area to calculate the luminance ratio.

The second extraction processing unit 236 calculates an average luminance B1 of the pixels in the bounding box 80a and an average luminance B2 of the pixels in the image area outside the bounding box 80a. In a case where the luminance ratio (B1/B2) is smaller than a predetermined value (N in S44), the second extraction processing unit 236 determines that the first connected components included in the bounding box 80a are not to be separated and stops the separation process of the first connected components. The predetermined value may be, for example, three. At this point, the second extraction processing unit 236 may determine that the bounding box 80a does not include the marker image and discard the bounding box 80a.

In a case where the luminance ratio is equal to or greater than the predetermined value (Y in S44), the second extraction processing unit 236 examines whether the size and the shape of the bounding box 80a satisfy predetermined conditions (S46). Specifically, the second extraction processing unit 236 determines whether or not the number of pixels x in the horizontal direction and the number of pixels y in the vertical direction satisfy the following conditions 1 to 4.
(Condition 1) Xmin≤x≤Xmax
(Condition 2) Ymin≤y≤Ymax
(Condition 3) x/y≤Aspect_Thresh
(Condition 4) y/x≤Aspect_Thresh

The conditions 1 and 2 are conditions stipulating that the size of the bounding box 80a is in a predetermined range, that is, the bounding box 80a is not too large and not too small. When a plurality of marker images are incorrectly extracted as one set of first connected components, each marker image is always small (if each marker image is large, a plurality of marker images are not extracted as one set of first connected components). Therefore, the bounding box 80a with the number of pixels x and the number of pixels y equal to or smaller than Xmax and Ymax, respectively, is investigated. In addition, in a case where the bounding box 80a is too small, the possibility that the bounding box 80a includes a marker image is low. Therefore, the bounding box 80a with the number of pixels x and the number of pixels y equal to or greater than Xmin and Ymin, respectively, is investigated. The conditions 3 and 4 are conditions for excluding a long and narrow bounding box 80a from the investigation. If the second extraction processing unit 236 determines that the size and the shape of the bounding box 80a do not satisfy any one of the conditions 1 to 4 (N in S46), the second extraction processing unit 236 determines that the first connected components included in the bounding box 80a are not to be separated and stops the separation process of the first connected components.

If the second extraction processing unit 236 determines that the size and the shape of the bounding box 80a satisfy all of the conditions 1 to 4 (Y in S46), the second extraction processing unit 236 carries out a process for separating the first connected components included in the bounding box 80a. Specifically, the second extraction processing unit 236 searches for an area connected in four neighborhoods from the first connected components and extracts the second connected components of four neighboring pixels.

FIG. 21 illustrates a target area for extracting the second connected components of four neighboring pixels. This target area is an area in which the bounding box 80a is extended by one pixel to both sides in the horizontal direction and both sides in the vertical direction. In the extraction process of the second connected components, the second extraction processing unit 236 searches for an area in which pixels with equal to or greater than the second luminance are connected to one another in four neighborhoods. Although the second luminance may be the same as the first luminance, the second luminance may be higher than the first luminance. For example, the second luminance may be a luminance value of 160.

When the second extraction processing unit 236 finds an area in which pixels with equal to or greater than the second luminance are connected to one another in four neighborhoods, the second extraction processing unit 236 extracts this area as second connected components of four neighboring pixels (S48) and specifies a bounding box surrounding the second connected components (S50). In a case where the second extraction processing unit 236 does not extract a plurality of sets of second connected components from the first connected components (N in S52), the second extraction processing unit 236 determines that the first connected components included in the bounding box 80a are not to be separated and stops the separation process of the first connected components. On the other hand, in a case where the second extraction processing unit 236 extracts a plurality of sets of second connected components from the first connected components (Y in S52), the second extraction processing unit 236 separates the first connected components 78a included in the bounding box 80a into a plurality of sets of second connected components (S54).

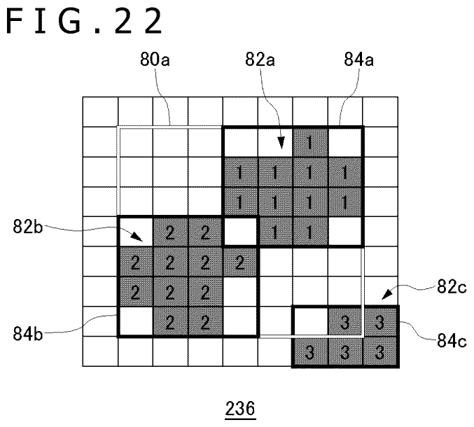

FIG. 22 illustrates bounding boxes surrounding the extracted second connected components of four neighboring pixels. In this example, the second extraction processing unit 236 extracts three sets of second connected components 82a, 82b, and 82c from the target area illustrated in FIG. 21 and specifies bounding boxes 84a, 84b, and 84c surrounding the sets of second connected components. Note that, in FIG. 22, the second extraction processing unit 236 provides a label value 1 to the second connected components 82a, a label value 2 to the second connected components 82b, and a label value 3 to the second connected components 82c according to the CCL algorithm. Here, the second connected components 82c provided with the label value 3 include pixels that are present outside the bounding box 80a. Therefore, the second extraction processing unit 236 recognizes that the second connected components 82c are not components separated from the first connected components 78a and excludes the second connected components 82c from the process.

In this example, the first connected components 78a connected in eight neighborhoods are separated into the second connected components 82a and the second connected components 82b in four neighborhoods. In a case where the second connected components 82a and the second connected components 82b satisfy a predetermined condition, the second extraction processing unit 236 replaces the first connected components 78a extracted by the first extraction processing unit 234 with the second connected components 82a and the second connected components 82b. Specifically, the second extraction processing unit 236 may discard the first connected components 78a and replace the first connected components 78a with the second connected components 82a and the second connected components 82b on condition that the numbers of pixels of the second connected components 82a and the second connected components 82b are equal to or greater than a predetermined value. This process can separate two marker images incorrectly extracted as one set of first connected components 78a. Note that, in a case where the first connected components 78a are separated into equal to or greater than a predetermined number of sets (for example, three or four), the second extraction processing unit 236 may determine that the separation process is not appropriate and maintain the first connected components 78a.

For all of the bounding boxes specified by the first extraction processing unit 234, the second extraction processing unit 236 investigates whether the first connected components that can be separated are included (N in S56). When the second extraction processing unit 236 finishes investigating all of the bounding boxes (Y in S56), the representative coordinate derivation unit 238 carries out a process of deriving representative coordinates of the marker image on the basis of the pixels of the first connected components extracted by the first extraction processing unit 234 and/or the pixels of the second connected components extracted by the second extraction processing unit 236.

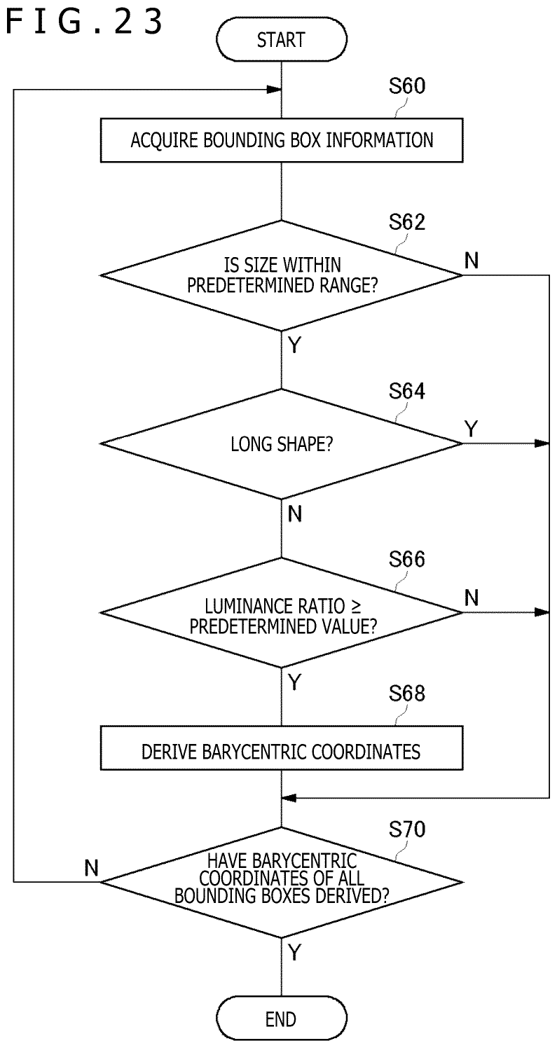

FIG. 23 illustrates a flow chart illustrating the derivation process of the representative coordinates. The representative coordinate derivation unit 238 uses the bounding box specified by the first extraction processing unit 234 and the bounding box specified by the second extraction processing unit 236, to derive the representative coordinates of the marker image. In the embodiment, the representative coordinate derivation unit 238 refers to some standards to examine whether the marker image is included in the bounding boxes specified by the first extraction processing unit 234 and the second extraction processing unit 236. The representative coordinate derivation unit 238 first acquires the bounding box information (S60) and examines whether the size of the bounding box is within the predetermined range (S62). In a case where the bounding box is too large (N in S62), the first connected components or the second connected components included in the bounding box are not an image of the photographed marker 30. Therefore, the representative coordinate derivation unit 238 discards the bounding box that is too large.

In a case where the size of the bounding box is within the predetermined range (Y in S62), the second extraction processing unit 236 examines whether the shape of the connected components of high luminance pixels included in the bounding box is a long shape (S64). The marker 30 has an emission surface with circular cross section. Therefore, the shape of the marker image is close to a circle and is not a long shape. In a case where the shape of the connected components of high luminance pixels is a long shape (Y in S64), the high luminance lighting body included in the bounding box is not the marker 30, and the representative coordinate derivation unit 238 discards the long-shaped bounding box.

In a case where the shape of the connection part of the high luminance pixels is not a long shape (N in S64), the representative coordinate derivation unit 238 checks the contrast between the specified bounding box and the surroundings of the bounding box (S66). The checking process of the contrast may be, for example, a process similar to the process illustrated in S44 of FIG. 19. In a case where the ratio of the average luminance in the bounding box to the average luminance in a predetermined area outside the bounding box is smaller than the predetermined value (N in S66), the representative coordinate derivation unit 238 discards the bounding box.

In a case where the luminance ratio is equal to or greater than the predetermined value (Y in S66), the representative coordinate derivation unit 238 recognizes that the marker image is included in the bounding box and derives the representative coordinates of the marker image on the basis of the pixels with equal to or greater than a third luminance in the bounding box (S68). The representative coordinates may be barycentric coordinates. The third luminance may be lower than the first luminance and may be, for example, a luminance value of 64. The representative coordinate derivation unit 238 calculates the luminance average position in the X-axis direction and the Y-axis direction and derives the representative coordinates (u, v). At this point, it is preferable that the representative coordinate derivation unit 238 take into account the pixel values of the pixels with equal to or greater than the third luminance to obtain the luminance center of gravity to thereby derive the representative coordinates (u, v).

In the description of the embodiment described above, the upper limit is set for the number of first connected components that can be extracted by the first extraction processing unit 234, in relation to S28 of FIG. 10. Note that, although the first extraction processing unit 234 forcibly ends the extraction process of the first connected components when the number of extracted first connected components reaches the upper limit number, the second extraction processing unit 236 may apply the above-described separation process to the extracted upper limit number of first connected components.

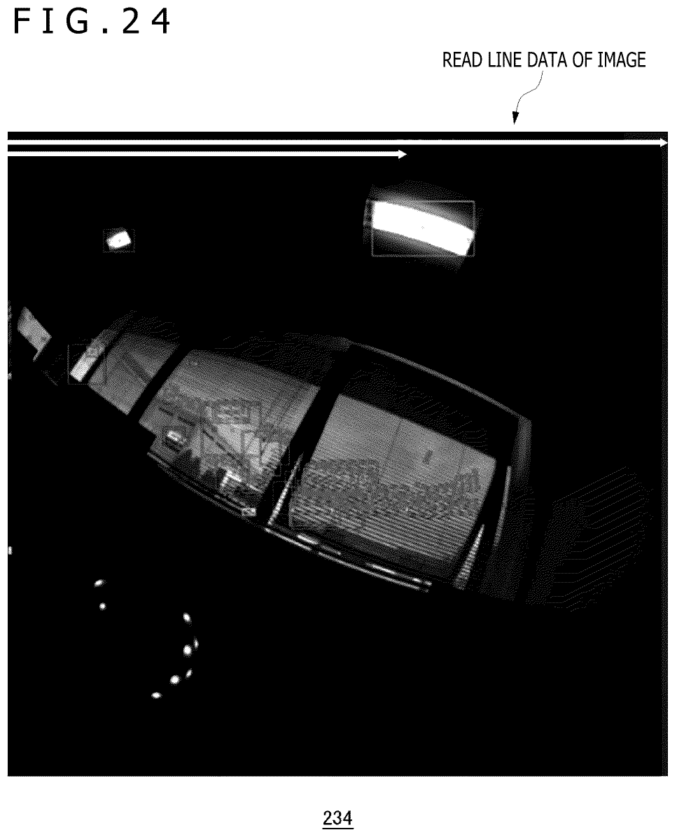

FIG. 24 illustrates an example of the bounding boxes extracted by the first extraction processing unit 234 in the photographed image. This photographed image includes blinds provided inside the windows for the purpose of sunshade, blindfold, or the like. The blinds photographed here are Venetian blinds including a plurality of horizontal blades (slats) lined up in the up-and-down direction, and the blinds of this type are often used in an office and the like.

The first extraction processing unit 234 of the embodiment includes hardware that sequentially acquires the line data of the image and that extracts the first connected components of eight neighboring pixels. Arrows illustrated in FIG. 24 illustrate the order of reading the line data of the image from the image sensor of the imaging device 14, and the first extraction processing unit 234 carries out the extraction process of the first connected components on the basis of the read line data. In the example illustrated in FIG. 24, as a result of the first extraction processing unit 234 sequentially carrying out the extraction process of the first connected components from top to bottom of the photographed image, the number of extracted first connected components has reached the upper limit number (256 components) before processing of the entire image data is finished, and the extraction process of the first connected components is forcibly finished. As illustrated in the photographed image of FIG. 24, the marker images of the photographed markers 30 of the input device 16 are on the lower left of the image. However, the number of extracted first connected components has reached the upper limit number, and the marker images are not extracted.

As also illustrated in FIG. 17, the input device 16 is photographed by the image sensor of the imaging device 14 installed on the HMD 100, and under the condition that the user normally plays the game, the input device 16 is photographed on the lower side in the angle of view. Therefore, the control unit 120 in the HMD 100 may vertically invert and read the image data from the image sensor of the imaging device 14 and transmit the read image data from the communication control unit 128 to the information processing apparatus 10.

In the information processing apparatus 10, the photographed image acquisition unit 212 acquires the image data vertically inverted and read from the image sensor. Therefore, the photographed image acquisition unit 212 sequentially acquires the line data of the photographed image from the lower part of the image and supplies the line data to the estimation processing unit 230 through the image signal processing unit 222. As a result, the first extraction processing unit 234 can extract the first connected components of a series of pixels with equal to or greater than the predetermined luminance from the image data vertically inverted and read from the image sensor, and the possibility of extracting the first connected components corresponding to the marker images present on the lower side of the photographed image before the number of extracted first connected components reaches the upper limit number can be increased.

The present disclosure has been described on the basis of the embodiment. The embodiment is illustrative, and those skilled in the art will understand that there can be various modifications for the combinations of the constituent elements and the processes of the embodiment and that the modifications are also included in the present disclosure. Although the information processing apparatus 10 carries out the estimation process in the embodiment, the function of the information processing apparatus 10 may be provided on the HMD 100, and the HMD 100 may carry out the estimation process. That is, the HMD 100 may be the information processing apparatus 10.

Although the arrangement of the plurality of markers 30 in the input devices 16 including the operation members 22 is described in the embodiment, the devices to be tracked may not include the operation members 22. Although the imaging devices 14 are attached to the HMD 100 in the embodiment, it is only necessary that the imaging devices 14 can photograph the marker images, and the imaging devices 14 may be attached to positions other than the HMD 100.

### INDUSTRIAL APPLICABILITY

The present disclosure can be used in a technical field of detecting marker images included in a photographed image.

### REFERENCE SIGNS LIST

1: Information processing system
10: Information processing apparatus
14: Imaging device
16a, 16b: Input device
20: Case body
21: Holding unit
22: Operation member
23: Curved unit
30: Marker
50: Control unit
52: Posture sensor
54: Communication control unit
58: Light source
100: HMD
102: Output mechanism unit
104: Attachment mechanism unit
106: Attachment band
108: Housing
120: Control unit
122: Storage unit
124: Posture sensor
126: Microphone
128: Communication control unit
130: Display panel
132: Sound output unit
200: Processing unit
202: Communication unit
210: Acquisition unit
212: Photographed image acquisition unit
214: Sensor data acquisition unit
216: Operation information acquisition unit
220: Game execution unit
222: Image signal processing unit
230: Estimation processing unit
232: Marker image coordinate specifying unit
234: First extraction processing unit
236: Second extraction processing unit
238: Representative coordinate derivation unit
240: Marker image coordinate extraction unit
242: Position and posture derivation unit
250: Marker information holding unit

The invention claimed is:

1. An information processing apparatus comprising:
a photographed image acquisition unit that acquires an image of a photographed device including a plurality of markers; and
an estimation processing unit that estimates position information and posture information of the device on a basis of a marker image in the photographed image, wherein
the estimation processing unit includes a marker image coordinate specifying unit that specifies representative coordinates of the marker image from the photographed image, and
a position and posture derivation unit that uses the representative coordinates of the marker image to derive the position information and the posture information of the device,
the photographed image acquisition unit acquires image data vertically inverted and read from an image sensor, and the marker image coordinate specifying unit includes an extraction processing unit that extracts connected components of a series of pixels from the image data vertically inverted and read from the image sensor, and
a representative coordinate derivation unit that derives the representative coordinates of the marker image on a basis of the pixels of the connected components extracted by the extraction processing unit.

2. The information processing apparatus according to claim 1, wherein the extraction processing unit extracts a plurality of sets of connected components within a predetermined upper limit number.

3. The information processing apparatus according to claim 2, wherein the extraction processing unit ends the extraction process of the connected components when the number of extracted connected components reaches the predetermined upper limit number.

4. The information processing apparatus according to claim 1, wherein the extraction processing unit includes hardware and extracts the connected components from line data of the image vertically inverted and read from the image sensor.

5. The information processing apparatus according to claim 1, wherein the image sensor is installed on a head-mounted display.

6. A representative coordinate derivation method comprising:
acquiring image data vertically inverted and read from an image sensor that has photographed a device including a plurality of markers;
extracting connected components of a series of pixels from the image data; and
deriving representative coordinates of a marker image on a basis of the pixels of the extracted connected components.

7. A program for a computer, comprising:
by a photographed image acquisition unit acquiring image data vertically inverted and read from an image sensor that has photographed a device including a plurality of markers;
by an extraction processing unit, extracting connected components of a series of pixels from the image data; and
by a representative coordinate derivation unit, deriving representative coordinates of a marker image on a basis of the pixels of the extracted connected components.
